(19) United States
(12) Patent Application Publication
(10) Pub. No.: US 2016/0297082 A1
(43) Pub. Date: Oct. 13, 2016

(54) RESTRICTED CONTAMINATION ENVIRONMENT APPARATUS

(71) Applicant: Gary L. Hanley, Malone, NY (US)

(72) Inventor: Gary L. Hanley, Malone, NY (US)

(21) Appl. No.: 14/808,583

(22) Filed: Jul. 24, 2015

Related U.S. Application Data
(60) Provisional application No. 62/144,703, filed on Apr. 8, 2015.

(51) Int. Cl. B25J 21/02; A61J 3/00

(52) U.S. Cl. CPC B25J 21/02; A61J 3/002

(57) ABSTRACT

A restricted contamination environment device allows the production (compounding) of sterile drugs products or other products that may need processing in a sterile (restricted contamination—either viable or non-viable) environment. The device can be used to prepare a “single dose” (making one dose, or single application only), prepare multiple single doses, and prepare multiple dose dispensers or to prepare multiples of multiple dose dispensers. In one example, a collapsible container is packaged with the vials, containers, syringes, parts and/or accessories within the container. The container may be folded or collapsed to minimize space prior to use. The container may then be “inflated” by some means either external or internal that would maintain the “contamination” free environment.

### CROSS-REFERENCE TO RELATED APPLICATIONS

This application claims the benefit of priority of U.S. provisional patent application No. 62/144,703, filed Apr. 8, 2015, the contents of which are herein incorporated by reference.

### BACKGROUND OF THE INVENTION

The present invention relates to environmental control measures and, more particularly, to a device that allows the production, or compounding, of sterile drug products, hazardous drugs or materials and other products that may need processing in a sterile or restricted contamination environment.

Compounding pharmacies often run into difficulties with respect to maintaining a proper environment for preparing drugs for patients or hospitals.

In 2013, in surprise inspections of large-scale compounding pharmacies, the FDA uncovered 39 safety deficiencies at four facilities. The visits were part of a targeted campaign focusing on companies “that pose the greatest risk”—those that compound sterile injectable products such as steroids and have a history of problems linked to patient illnesses or death.

Compounding pharmacies have been in the spotlight since a fungal meningitis outbreak was identified in October 2012. As of Mar. 4, 2013, the outbreak had caused the deaths of 48 people and sickened 672 others, according to CDC. The outbreak was traced to contaminated injectable steroids manufactured in unsanitary conditions at the New England Compounding Center in Framingham, Mass.

As the FDA cracks down on compliance, compounding pharmacies have the difficult task of ensuring their procedures and processes are acceptable and safe. Many times, compounding pharmacies do not have the means to develop and maintain clean rooms or other areas for compounding.

As can be seen, there is a need for a system and methods for handling and compounding pharmaceuticals in a safe and cost effective manner.

### SUMMARY OF THE INVENTION

In one aspect of the present invention, a container comprises a resilient outer shell forming an enclosed space therewithin; and at least one storage container containing a component requiring a restricted contamination environment, wherein the component is manipulated within the enclosed space without permitting contamination to enter therewithin.

In another aspect of the present invention, a container provides a restricted contamination environment for preparation of an active pharmaceutical ingredient, the container comprises a resilient outer shell forming an enclosed space therewithin; at least one storage container containing the active pharmaceutical ingredient; and at least manipulation port formed in at least a portion of the resilient outer shell, the manipulation port permitting manipulation of the at least one storage container within the enclosed space, wherein the active pharmaceutical ingredient is manipulated within the enclosed space without permitting contamination to enter therewithin.

In a further aspect of the present invention, a method of preparing a compounded pharmaceutical product comprises inflating an enclosed space formed within a resilient outer shell; manipulating at least at least one storage container containing an active pharmaceutical ingredient to form the compounded pharmaceutical product inside the enclosed space without permitting contamination to enter therewithin; and removing the compounded pharmaceutical product from inside the enclosed space.

These and other features, aspects and advantages of the present invention will become better understood with reference to the following drawings, description and claims.

### BRIEF DESCRIPTION OF THE DRAWINGS

FIG. 1 is a perspective view of a container with manipulation ports and an inflation port, according to an exemplary embodiment of the present invention;

FIG. 2 is a detailed side view of the inflation port of the container of FIG. 1;

FIG. 3 is a front view of vials designed to interconnect, according to an exemplary embodiment of the present invention; and

FIG. 4 is a detailed perspective view of a transfer panel optionally included on the container of FIG. 1, according to an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a device that allows the production (compounding) of sterile drugs products or other products that may need processing in a sterile (restricted contamination—either viable or non-viable) environment. The device can be used to prepare a “single dose” (making one dose, or single application only), prepare multiple single doses, and prepare multiple dose dispensers or to prepare multiples of multiple dose dispensers. In one embodiment, the present invention provides a collapsible container that is packaged with the vials, containers, syringes, parts and/or accessories within the container. The container may be folded or collapsed to minimize space prior to use. The container may then be “inflated” by some means either external or internal that would maintain the “contamination” free environment.

In this embodiment, the manipulation of drug vials, containers, syringes, Luer fittings, communication fittings, parts and accessories takes place inside the “bubble” of the container. Operations may be facilitated by manipulation ports integral with the sterile (closed) environment enclosure.

In an alternate embodiment, the container, depending on the required contents, may not have a “manipulation port” but will be able to facilitate the required procedure by solely providing a contamination free environment inside the device. In this embodiment, the user may manipulate the contents by simply holding and moving the contents from outside the container by squeezing the container itself from its exterior.

In some embodiments, the container may be designed to allow “sterile” (read non-contamination) communication ports in order to gain access to items not contained within the container. These items may need to be required to present bulk material to the closed system, for example. A typical communication port would be made out of an elastomer type material in the side of the container that could be sterilized, by, for example, the use of sterile isopropyl alcohol or a disinfecting agent, and would allow a “sterile” connection to be made with the outside container. For example, a vial containing drug substance, an IV bag with a drug port, or the like, may be pressed against the communication port on the exterior of the container and a syringe, for example, within the container may be used to deliver product to the outside of the container or bring product into the container. The port may also be used to allow exit of the material into a secondary vessel, container, vial, bag, IV administration device, syringe or the like.

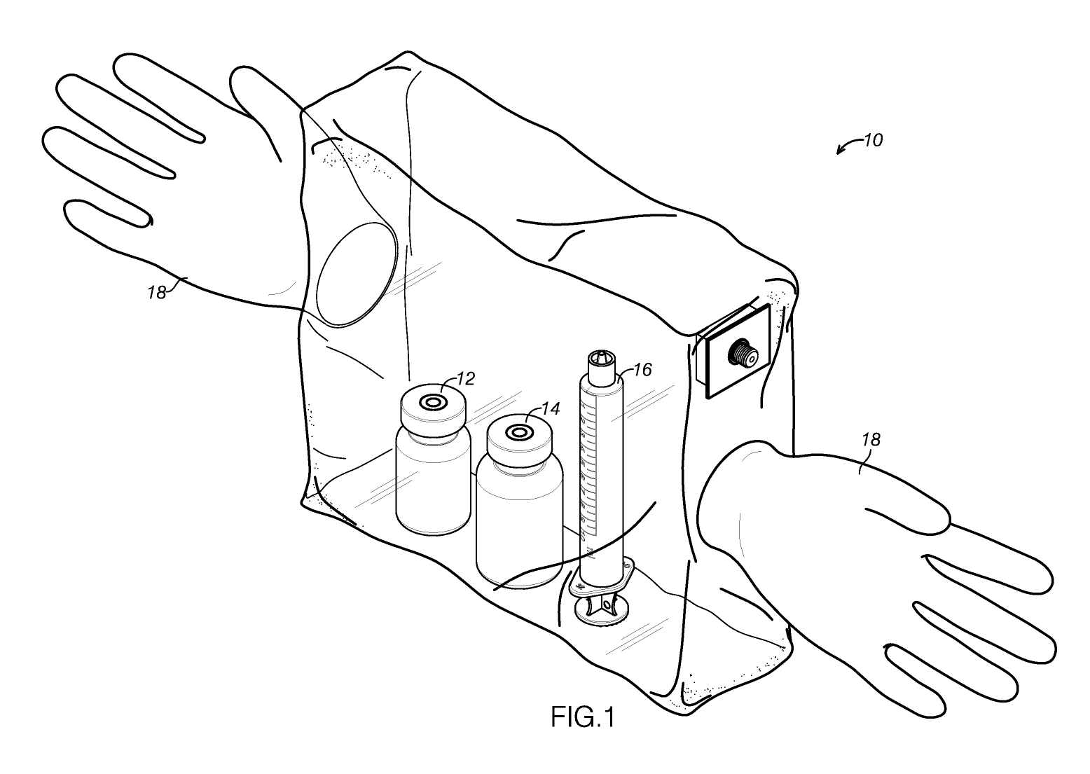

Referring now to FIGS. 1 through 3, a container 10 may be formed from a flexible polymeric material that may be expanded and collapsed without damaging the material forming the container 10. The container 10 may be made, for example, by a blow fill process.

Various items may be disposed within the container 10. For example, a first vial 12 and a second vial 14 may be disposed within the container 10. The first vial 12 may be, for example, an active pharmaceutical agent, while the second vial 14 may be a diluent, or a second active pharmaceutical agent, or the like. While the Figure shows two vials 12, 14, more than two vials may be present, depending on the needs of the final compounded drug product to be made. A syringe 16, or other material or fluid transfer device, may be disposed inside the container 10. A pharmaceutical compounder may use the syringe 16 to, for example, remove the contents of the first vial 12 and add them to the contents of the second vial 14. The second vial 14 may then be removed from the container and delivered to the patient, hospital, or the like. The result is a sterile, contamination-free environment in which the drug product is compounded. The containers 10 may be manufactured with various drug products and manipulation tools (such as syringe 16) inside the container 10, so that the mixing (compounding) of the drug product can be performed inside the sealed container without risking contamination.

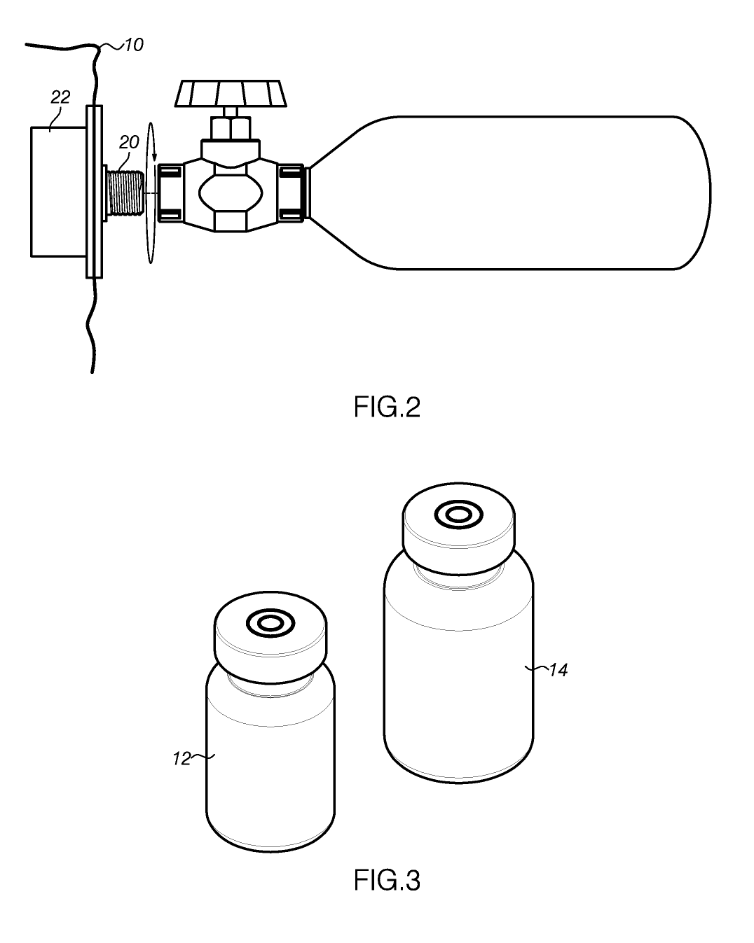

Typically, the container 10, with its contents (such as vials 12, 14 and syringe 16, for example) is manufactured in a “deflated” state. Such a state may be useful for shipping or storage. However, the container may also be manufactured in its already inflated state (as shown in FIG. 1). If deflated, various means can be used to inflate the container 10. For example, as shown in FIG. 2 a port 20 may be provided to allow an inert gas, such as nitrogen gas, to be inserted therein. A filter 22 may be present to help ensure the inert gas is pure. A one-way valve (not shown) may be used to prevent the gas from escaping from the inflated container 10. In other embodiments, the container 10 may be inflated with a self-contained inflation unit, such as a cylinder of compressed gas. Other inflation mechanisms may be included within the scope of the present invention.

Referring back to FIG. 1, manipulation ports 18 may be provided in the container 10. The manipulation ports 18 may be, for example, glove-like portions into which a user may insert their hands. The manipulation ports 18 may be sufficiently flexible to allow the user's hands, when inserted therein, to manipulate contents within the container 10. Typically, two manipulation ports 18 may be disposed on opposite sides of the container 10, as shown, although other configurations and numbers of manipulation ports are contemplated within the scope of the present invention.

In some embodiments, there may not be any manipulation ports.

Instead, the user may simply flex the exterior of the container to permit manipulation of the contents therewithin. Of course, in this embodiment, the “inflation” of the container 10 may be reduced to permit ease of access without having to overly stretch the container 10.

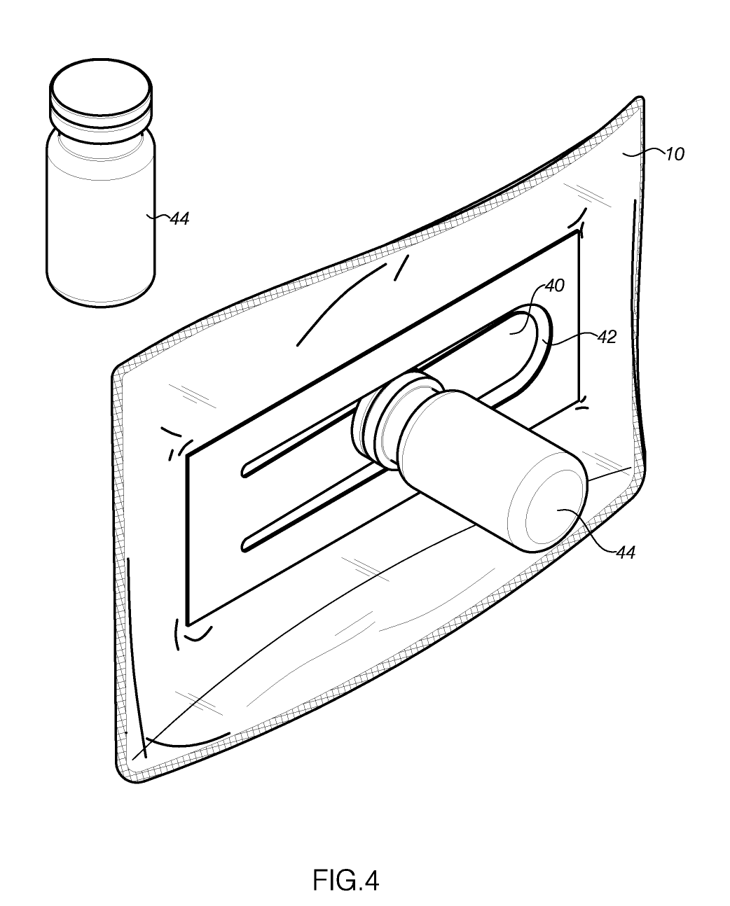

Referring to FIG. 3, in some embodiments, the vials 12, 14 within the container 10 may be configured with connections that permit the interconnection of the vials without the need of a syringe to combine their contents. For example, the first vial 12 may include a male Luer lock connection and the second vial 14 may include a female Luer lock connection. The user, to mix the contents, may remove the caps of the vials 12, 14 and lock them together. The present invention includes this method, the syringe discussed above, and other methods of mixing contents within the container 10.

Referring now to FIG. 4, in some embodiments, it may be desired to move a substance from inside to outside the container 10, or from outside to inside the container 10. A transfer panel 40 may be provided for this purpose, where an elastomeric panel may be designed to be cleaned on the exterior (with, for example, isopropyl alcohol) and may be designed to be penetrated by a syringe needle or the like. The elastomeric panel may be made out of various material, similar to a vial septum, that self closes after the needle is removed.

A locking mechanism 42 can be provided to lock the outside container 44 to the transfer panel 40. The locking mechanism can be, for example, a pair of bars into which the neck of the outside container 44 (such as a vial neck) may slide into and be secured therein. The outside container 44 may be a vial, an IV bag port, or the like. The transfer panel 40 may take different forms as may be contemplated by one skilled in the art.

The container and related methods of the present invention provide several advantages over the current standards used in compounding pharmacies. These advantages include the following: (1) Create and maintain sterile (non-contaminated) field around the product/products and accessories, eliminating the requirement for an aseptic hood or external aseptic/sterile or non-contaminated field; (2) All products, vials, syringes, fittings and accessories inside the “closed” system would be terminally sterilized in place to eliminate possible contamination; (3) The closed chamber container could be validated to maintain “sterility” or contamination free environment; (4) Terminal sterilization allows validation of “sterile” environment. Biological indicators could be present in the bag prior to terminal sterilization and would remain in place, attesting to sterile field; (5) Product vials included within the container could be tested for sterility and endotoxins prior to including in the container, doing so would allow formal validation of sterility and endotoxin profiles of final drug product; (6) The container would allow validation of clean cGMP processing due to control of variable parameters; (7) The container would eliminate the requirements for gowning to perform the compounding or manipulations inside the device; (8) In drug product compounding, the container could hold the bulk pharmaceutical ingredients with an extended expiration until the final drug was compounded and final drug expiration is defined. Stability of the bulk product could be established allowing extended “shelf life” prior to compounding and development of “Beyond Use Date” (BUD) at the time of compounding; (9) The container may solely act as a single source for products to compound a drug with the bulk ingredients enclosed in the “closed System”; and (10) The container is intended to facilitate the validation of a number of systems to comply with current Good Manufacturing Practices along with USP 795, USP 797 and World Health guidelines. These would include; Sterility Validation, Bulk ingredient stability, Endotoxin Validation, Environmental Monitoring Validation, Cleaning Validation, Gowning qualification, Contamination Control Validation, Product Stability Validation, Equipment Control and Validation, Air Quality Control Validation and Process Validation.

While the above description refers to vials being used to store separate ingredients for compounding, for example, the vials may be various containers, including jars, bags, or the like. The contents of the vials, or other such containers, may be liquids, solids, suspensions, or the like.

While the above description focused on the use of the container in a pharmaceutical compounding function, the container of the present invention may be useful in any industry where a contamination-free environment is needed for manipulating objects, products, or the like.

It should be understood, of course, that the foregoing relates to exemplary embodiments of the invention and that modifications may be made without departing from the spirit and scope of the invention as set forth in the following claims.

What is claimed is:

1. A container comprising:
a resilient outer shell forming an enclosed space therewithin; and
at least one storage container containing a component requiring a restricted contamination environment, wherein
the component is manipulated within the enclosed space without permitting contamination to enter therewithin.

2. The container of claim 1, further comprising at least manipulation port formed in at least a portion of the resilient outer shell, the manipulation port permitting manipulation of the at least one storage container within the enclosed space.

3. The container of claim 2, wherein the manipulation port includes at least one glove-shaped protrusion into the enclosed space, wherein the manipulation port is integral with the resilient outer shell so as to maintain the restricted contamination environment within the enclosed space.

4. The container of claim 3, wherein the at least one glove-shaped protrusion includes two glove-shaped protrusions on opposite sides of the resilient outer shell.

5. The container of claim 1, further comprising means for inflating the container.

6. The container of claim 5, wherein the means for inflating the container includes means for introducing an inert gas into the enclosed space.

7. The container of claim 1, further comprising a transfer panel operable to transfer a substance from a container located outside of the enclosed space to within the enclosed space.

8. The container of claim 1, wherein the component is an active pharmaceutical ingredient.

9. The container of claim 8, wherein the at least one storage container includes at least two storage containers configured to be mixed together inside the enclosed space of the container.

10. The container of claim 9, wherein the at least two storage containers include a mating connector on each of the at least two storage containers, the mating connector permitting two of the at least two storage containers to mate together to transfer contents from one to the other thereof.

11. A container providing a restricted contamination environment for preparation of an active pharmaceutical ingredient, the container comprising:
a resilient outer shell forming an enclosed space therewithin;
at least one storage container containing the active pharmaceutical ingredient; and
at least manipulation port formed in at least a portion of the resilient outer shell, the manipulation port permitting manipulation of the at least one storage container within the enclosed space, wherein
the active pharmaceutical ingredient is manipulated within the enclosed space without permitting contamination to enter therewithin.

12. The container of claim 11, wherein the manipulation of the active pharmaceutical ingredient includes compounding the active pharmaceutical ingredient.

13. The container of claim 11, wherein the enclosed space is at least partially deflated prior to use.

14. The container of claim 13, further comprising means for inflating the container.

15. The container of claim 11, wherein the manipulation port includes two glove-shaped protrusions into the enclosed space at opposite sides of the container, wherein the manipulation ports are integral with the resilient outer shell so as to maintain the restricted contamination environment within the enclosed space.

16. The container of claim 11, further comprising a transfer panel operable to transfer a substance from a container located outside of the enclosed space to within the enclosed space.

17. A method of preparing a product in a restricted contamination environment comprising:
inflating an enclosed space formed within a resilient outer shell;
manipulating at least one storage container containing at least one ingredient to form the product inside the enclosed space without permitting contamination to enter therewithin; and
removing the product from inside the enclosed space.

18. The method of claim 17, wherein the step of removing the product from inside the enclosed space includes removing the product through a transfer panel disposed on at least a portion of the resilient outer shell.

19. The method of claim 17, wherein the product is a compounded pharmaceutical product.

20. The method of claim 17, further comprising manipulating the at least one storage container via at least one manipulation port, wherein the at least one manipulation port is integral with the resilient outer shell so as to maintain the restricted contamination environment within the enclosed space.
